(19) United States
(12) Patent Application Publication
(10) Pub. No.: US 2007/0121670 A1
(43) Pub. Date: May 31, 2007

(54) Method for converting, editing and modifying communication protocol

(75) Inventor: Cheng Ping Chen, Taoyuan City (TW)

Correspondence Address: HDSL, 4331 STEVENS BATTLE LANE, FAIRFAX, VA, 22033, US

(73) Assignee: Delta electronics, Inc.

(21) Appl. No.: 11/288,351

(22) Filed: Nov. 29, 2005

(51) Int. Cl. H04J 3/16

(52) U.S. Cl. 370/466; 370/401

(57) ABSTRACT

A method for converting, editing and modifying communication protocol. A computer is connected to a plurality of communication protocol converting modules through a master bus. The plurality of communication protocol converting modules is connected to corresponding slave buses and each of the slave buses is connected to a plurality of devices. The communication protocol-converting module is capable of converting communication protocol, editing and modifying communication commands. The command protocols of the computer and the command protocols of the devices are stored in the communication protocol converting module, whereby the communication protocol converting module has capability for group communication to integrate each independent communication group.

### BACKGROUND OF THE INVENTION

1. Field of the Invention

The present invention relates to a method for converting, editing and modifying communication protocol by using a communication protocol conversion module between computer and devices.

2. Description of Prior Art

As the progress of technology, the industrial control mainly relies on the data exchange between equipments through communication network. FIG. 1 shows a schematic diagram of two conventional communication networks. In the first communication network 10, a computer 12 is connected to equipments of various types through a first bus 14 and the computer 12 communicates with the equipments of various types through a specific protocol. In the second communication network 20, a computer 22 is connected to equipments of various types through a first bus 24 and the computer 22 communicates with the equipments of various types through another specific protocol.

In FIG. 1, the separate communication network is composed of element with specific network protocol. The computers 1 and 2 access the equipments of various types in group manner and should cooperate with another computer if the equipments of different communication protocol are to be accessed. The integration degree for this kind of architecture is poor and separate computers are needed for separate communication networks.

### SUMMARY OF THE INVENTION

The present invention is to provide a method for converting, editing and modifying communication protocol by using a communication protocol conversion module between computer and devices. The communication protocol conversion module has feature of protocol conversion and editing and modifying communication commands. The communication command protocols of computer and device are recorded in the communication protocol conversion module such that the communication protocol conversion module has group communication protocol ability to integrate each independent communication group.

Accordingly, the present invention provides a method for converting communication protocol used for a computer system. The computer system comprises a computer connected to a plurality of communication protocol conversion modules through a master bus, the communication protocol conversion modules connected to a plurality of devices through corresponding slave buses. The method comprises the steps of: the computer initializing the communication protocol conversion modules through the master bus; a communication protocol conversion module designated by the computer receiving a packet from the master bus; the designated communication protocol conversion module converting the packet to a device packet, the device packet being data converted by the designated communication protocol conversion module; the designated communication protocol conversion module sending the device packet to a designated device through a corresponding slave bus; the designated communication protocol conversion module waiting a reply message from the designated device; and the designated communication protocol conversion module converting the reply message to a computer-recognizable reply message and sending the computer-recognizable reply message to the computer through the master bus.

Accordingly, the present invention provides a method for editing and modifying a communication protocol used for a computer system. The computer system comprises a computer connected to a plurality of communication protocol conversion modules through a master bus, the communication protocol conversion modules connected to a plurality of devices through corresponding slave buses. The computer edits or modifies the communication protocol for the communication protocol conversion modules. The communication protocol conversion modules with the edited and modified communication protocol sends data conversion protocol of computer to the devices. The method comprises the steps of: the computer initializing the communication protocol conversion modules through the master bus; the communication protocol conversion modules waiting for commands issued from the computer; one the communication protocol conversion modules sending a reply message to a display of the computer in response to the command issued from the computer; the display showing a command prompt character for the communication protocol conversion module; the communication protocol conversion modules waiting for an editing/modifying command issued from the computer; judging whether the communication protocol conversion modules receiving an editing command issued from the computer; when the communication protocol conversion module receiving an editing command issued from the computer, the computer sending a communication command protocol to the communication protocol conversion module for editing; saving the communication command protocol to a storage unit of the communication protocol conversion module for editing; when the communication protocol conversion module does not receive the modifying command issued from the computer, the method is back to the step of the communication protocol conversion modules waiting for an editing/modifying command issued from the computer; when the communication protocol conversion modules receiving the modifying command issued from the computer; selecting a communication protocol number to modify the communication protocol conversion module corresponding to the communication protocol number and requiring modification; the communication protocol conversion module requiring modification outputting the communication command protocol to the computer; the computer sending a modified communication command protocol to the communication protocol conversion module; and storing the modified communication command protocol to the storage unit of the communication protocol conversion module.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a schematic diagram of two conventional communication networks.

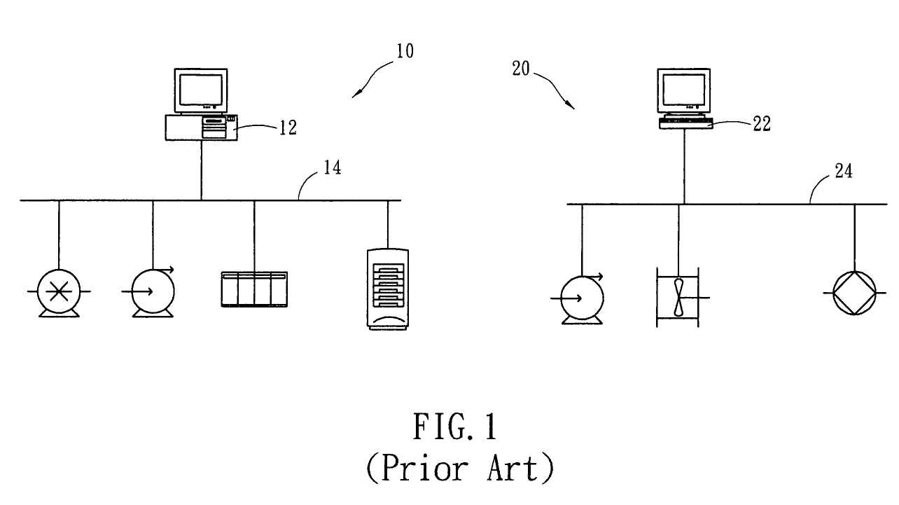

FIG. 2 shows the network communication system according to a preferred embodiment of the present invention.

FIG. 3 shows the block diagram of the differential-transmission based communication protocol conversion module.

FIG. 4 is a flowchart showing the steps of communication protocol conversion.

FIG. 5 shows the steps of method of editing and modifying communication protocol according to the present invention.

### DETAILED DESCRIPTION OF THE INVENTION

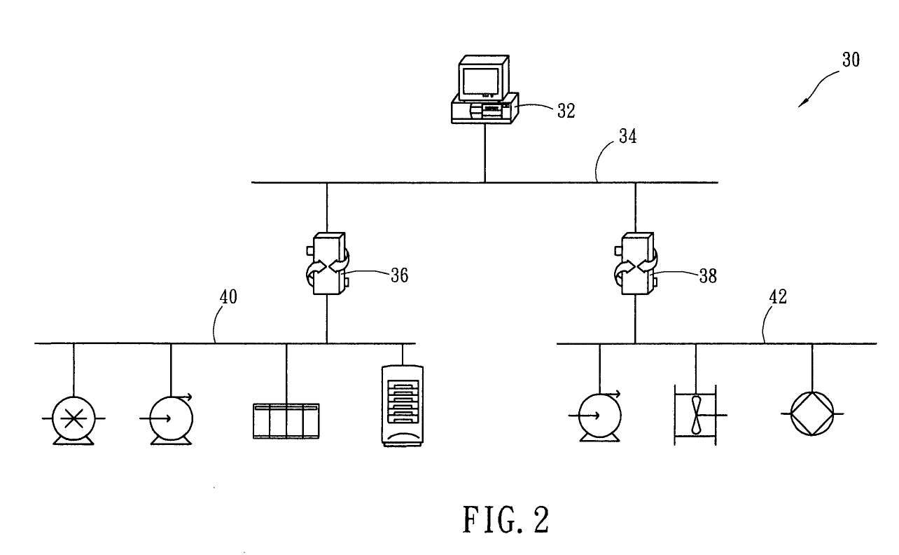

FIG. 2 shows the network communication system according to a preferred embodiment of the present invention. In the network communication system 30 shown in FIG. 2, a computer 32 is connected to a master bus 34 and the master bus 34 is connected to a first differential-transmission based communication protocol conversion module 36 and a second differential-transmission based communication protocol conversion module 38. It should be noted while the present invention is exemplified with two kinds of communication protocol conversion modules, the scope of the present invention is not limited to two kinds of communication protocol conversion modules. The first differential-transmission based communication protocol conversion module 36 and the second differential-transmission based communication protocol conversion module 38 are connected to devices of various type through corresponding first slave bus 40 and second slave bus 42.

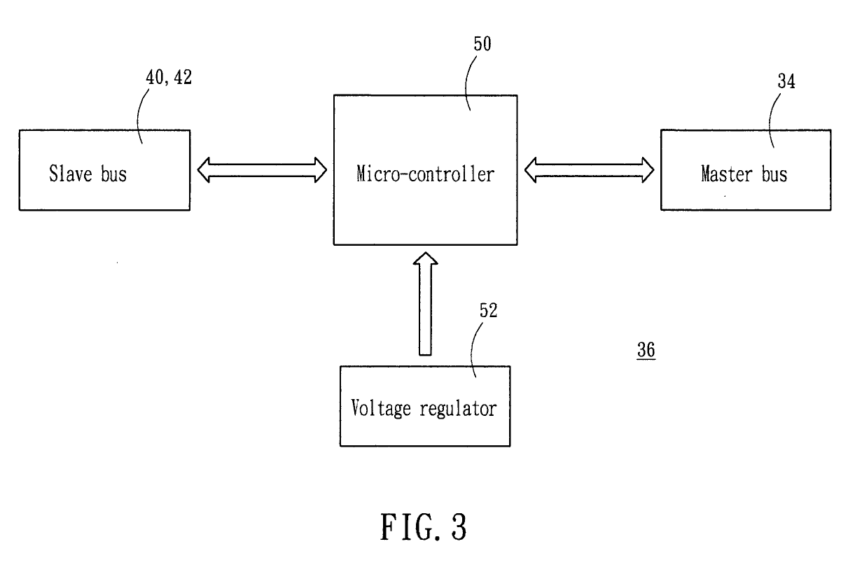

FIG. 3 shows the block diagram of the differential-transmission based communication protocol conversion module, which is exemplified with the first differential-transmission based communication protocol conversion module 36, while the second differential-transmission based communication protocol conversion module 38 has similar description. The first differential-transmission based communication protocol conversion module 36 comprises a microcontroller 50 and a voltage regulator 52. The microcontroller 50 receives a packet from the master bus 34 and converts the packet into a device packet and then sends the device packet to the slave bus 40. The microcontroller 50 further receives a reply message from the slave bus 40 and converts the reply message into a computerized reply message and then sends the computerized reply message to the master bus 34. The voltage regulator 52 supplies electrical power to the microcontroller 50.

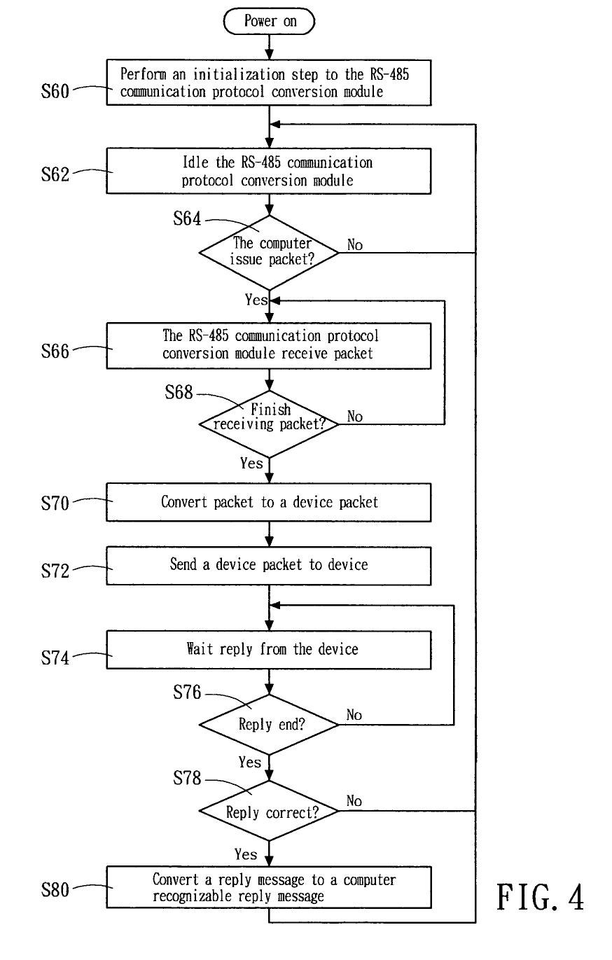

FIG. 4 is a flowchart showing the steps of communication protocol conversion. With reference also to FIG. 2, in step S60, the computer 32 performs an initialization step to the first differential-transmission based communication protocol conversion module 36 and the second differential-transmission based communication protocol conversion module 38 through the master bus 34. The computer 32 initializes the communication protocol conversion mode according to the attributions of devices connected to the slave buses 40 and 42 corresponding to the e first differential-transmission based communication protocol conversion module 36 and the second differential-transmission based communication protocol conversion module 38. When the computer 32 does not issue packet, the first differential-transmission based communication protocol conversion module 36 and the second differential-transmission based communication protocol conversion module 38 are idled in step S62.

Afterward, step S64 judges whether the computer 32 has sent a packet to the master bus 34. When the computer 32 has not sent a packet to the master bus 34, the procedure is back to step S62. When the computer 32 has sent a packet to the master bus 34, a differential-transmission based communication protocol conversion module designated by the computer 32 receives a packet sent by from the master bus 34 at step S66. Hereinafter this procedure is exemplified with the first differential-transmission based communication protocol conversion module 36. The first differential-transmission based communication protocol conversion module 36 converts the received packet to a device packet, where the device packet is converted from data sent by the computer 32 and sent to a designated device.

Step S68 judges whether the first differential-transmission based communication protocol conversion module 36 had finished receiving packet. When the packet receiving is not finished, the procedure is back to step S66. When the packet receiving is finished, the first differential-transmission based communication protocol conversion module 36 converts the received packet to a device packet at step S70. Moreover, the first differential-transmission based communication protocol conversion module 36 sent the device packet to a designated device through the first slave bus 40 at step S72.

The first differential-transmission based communication protocol conversion module 36 waits for a reply message from the designated device at step S74. Step S76 judges whether the first differential-transmission based communication protocol conversion module 36 finishes receiving the reply message through the first slave bus 40. When the first differential-transmission based communication protocol conversion module 36 has not finished receiving the reply message, the procedure is back to step S74.

When the first differential-transmission based communication protocol conversion module 36 has finished receiving the reply message, step S78 judges whether the reply message received by the first differential-transmission based communication protocol conversion module 36 is correct. When the reply message received by the first differential-transmission based communication protocol conversion module 36 is correct, the first differential-transmission based communication protocol conversion module 36 converts the reply message to a computer-recognizable reply message and sends the computer-recognizable reply message to the computer through the master bus 34. Afterward, the process is back to step S62.

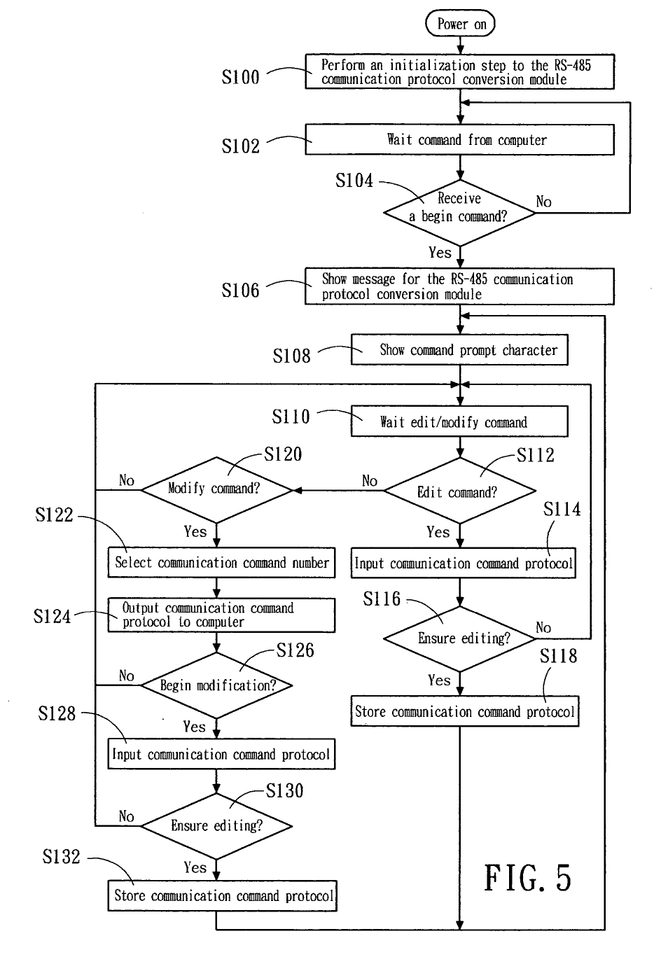

FIG. 5 shows the steps of method of editing and modifying communication protocol according to the present invention. At step S100, the computer 32 initializes the first differential-transmission based communication protocol conversion module 36 and the second differential-transmission based communication protocol conversion module 38. Then the first differential-transmission based communication protocol conversion module 36 and the second differential-transmission based communication protocol conversion module 38 waits for command issued from the computer 32 at step S102.

Step S104 judges whether the first differential-transmission based communication protocol conversion module 36 and the second differential-transmission based communication protocol conversion module 38 receive a begin command from the computer 32. When the first differential-transmission based communication protocol conversion module 36 and the second differential-transmission based communication protocol conversion module 38 have not received the begin command from the computer 32, the procedure is back to step S102. When the first differential-transmission based communication protocol conversion module 36 and the second differential-transmission based communication protocol conversion module 38 have received the begin command from the computer 32, a display (not shown) shows a reply message sent from the first differential-transmission based communication protocol conversion module 36 and the second differential-transmission based communication protocol conversion module 38 and to the computer 32 at step S106.

The display shows a command prompt character for the first differential-transmission based communication protocol conversion module 36 and the second differential-transmission based communication protocol conversion module 38 at step S108. The first differential-transmission based communication protocol conversion module 36 and the second differential-transmission based communication protocol conversion module 38 waits an editing/modifying communication command from the computer 32 at step S110.

Afterward, step S112 judges whether the first differential-transmission based communication protocol conversion module 36 and the second differential-transmission based communication protocol conversion module 38 receives an editing communication command. When the first differential-transmission based communication protocol conversion module 36 and the second differential-transmission based communication protocol conversion module 38 have received the editing communication command, the computer 32 sends a communication command protocol to the communication protocol conversion module to be edited in step S114. The preferred embodiment is exemplified with the first differential-transmission based communication protocol conversion module 36.

Afterward, step S116 judges whether the first differential-transmission based communication protocol conversion module 36 needs to edit. When the first differential-transmission based communication protocol conversion module 36 does not need to edit, the procedure is back to step S110. When the first differential-transmission based communication protocol conversion module 36 needs to edit, the communication command protocol is stored in a storage unit (not shown) of the first differential-transmission based communication protocol conversion module 36 in step S118 and then the procedure is back to step S108, where the storage unit can be a non-volatile memory.

When the first differential-transmission based communication protocol conversion module 36 and the second differential-transmission based communication protocol conversion module 38 do not receive an editing communication command, step S120 judges whether the first differential-transmission based communication protocol conversion module 36 and the second differential-transmission based communication protocol conversion module 38 receives a modifying communication command. When the first differential-transmission based communication protocol conversion module 36 and the second differential-transmission based communication protocol conversion module 38 do not receive the modifying communication command, the procedure is back to step S110. When the first differential-transmission based communication protocol conversion module 36 and the second differential-transmission based communication protocol conversion module 38 receive the modifying communication command, a communication command number is selected to modify the communication protocol conversion module corresponding to the communication command number in step S122. The preferred embodiment is exemplified with the second differential-transmission based communication protocol conversion module 38. Afterward, the second differential-transmission based communication protocol conversion module 38 sends the communication command protocol to the computer 32 in step S124.

Step S126 judges whether the communication command protocol is to be modified. When communication command protocol is not to be modified, the procedure is back to step S110. When communication command protocol is to be modified, the computer sends the modified communication command protocol to the second differential-transmission based communication protocol conversion module 38 in step S128. Step 128 judges whether the second differential-transmission based communication protocol conversion module 38 needs to edit. When the second differential-transmission based communication protocol conversion module 38 does not need to edit, the procedure is back to step S110. When the second differential-transmission based communication protocol conversion module 38 needs to edit, the modified communication command protocol is stored in a storage unit of the second differential-transmission based communication protocol conversion module 38 in step S132 and then the procedure is back to step S108.

The present invention exploits the conversion property of differential-transmission based communication protocol conversion module and the feature of editing and modifying communication command. The communication command protocol of computer and the communication command protocol of device are written into the differential-transmission based communication protocol conversion module. Therefore, the differential-transmission based communication protocol conversion module has the ability of group communication and the independent communication groups can be integrated to enhance utility of network system.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A method for converting communication protocol used for a computer system, the computer system comprising a computer connected to a plurality of communication protocol conversion modules through a master bus, the communication protocol conversion modules connected to a plurality of devices through corresponding slave buses, the method comprising the steps of:
the computer initializing the communication protocol conversion modules through the master bus;
a communication protocol conversion module designated by the computer receiving a packet from the master bus;
the designated communication protocol conversion module converting the packet to a device packet, the device packet being data converted by the designated communication protocol conversion module;
the designated communication protocol conversion module sending the device packet to a designated device through a corresponding slave bus;
the designated communication protocol conversion module waiting a reply message from the designated device; and
the designated communication protocol conversion module converting the reply message to a computer-recognizable reply message and sending the computer-recognizable reply message to the computer through the master bus.

2. The method as claim 1, wherein the communication protocol conversion module is a differential-transmission based communication protocol conversion module and the differential-transmission based communication protocol conversion module comprises:
a micro controller converting a packet received from the master bus to a device packet and sending the device packer to corresponding slave bus, the micro controller converting the reply message from the slave bus to the computer-recognizable reply message and sending the computer-recognizable reply message to the master bus; and
a voltage regulator supplying electrical power to the micro controller.

3. The method as in claim 1, wherein when the computer initializes the communication protocol conversion modules through the master bus, the computer initializes a communication protocol conversion mode for each communication protocol conversion module according to an attribution of the device connected to the communication protocol conversion module through the corresponding slave bus.

4. The method as in claim 1, further comprising the step of idling the communication protocol conversion modules when the computer does not issue the packet.

5. The method as in claim 4, further comprising the steps of:
judging whether the computer sends the packet through the master bus;
when the computer does not send the packet through the master bus, the method is back to the step of idling the communication protocol conversion modules;
when the computer sends the packet through the master bus, the method proceeds to the step of a communication protocol conversion module designated by the computer receiving a packet from the master bus.

6. The method as in claim 4, further comprising the steps of:
judging whether the designated communication protocol conversion module finishes receiving the reply message from the slave bus;
when the designated communication protocol conversion module does not finish receiving the reply message from the slave bus, the method is back to the step of the designated communication protocol conversion module waiting a reply message from the designated device;
when the designated communication protocol conversion module finishes receiving the reply message from the slave bus, judging whether the reply message is correct;
when the reply message is not correct, the method is back to the step of idling the communication protocol conversion modules; and
when the reply message is correct, the method is back to the step of the designated communication protocol conversion module converting the reply message to a computer-recognizable reply message and sending the computer-recognizable reply message to the computer through the master bus.

7. The method as in claim 1, wherein the step of a communication protocol conversion module designated by the computer receiving a packet from the master bus further comprises following steps:
judging whether the communication protocol conversion module finishes receiving the packet;
when the communication protocol conversion module does not finish receiving the packet, the method is back to the step of a communication protocol conversion module designated by the computer receiving a packet from the master bus;
when the communication protocol conversion module finishes receiving the packet, the method is back to the step of the designated communication protocol conversion module converting the reply message to a computer-recognizable reply message and sending the computer-recognizable reply message to the computer through the master bus.

8. A method for editing and modifying a communication protocol used for a computer system, the computer system comprising a computer connected to a plurality of communication protocol conversion modules through a master bus, the communication protocol conversion modules connected to a plurality of devices through corresponding slave buses, the computer editing or modifying the communication protocol for the communication protocol conversion modules, the communication protocol conversion modules with the edited and modified communication protocol sending data conversion protocol of computer to the devices, the method comprising the steps of:
the computer initializing the communication protocol conversion modules through the master bus;
the communication protocol conversion modules waiting for commands issued from the computer;
one the communication protocol conversion modules sending a reply message to a display of the computer in response to the command issued from the computer;
the display showing a command prompt character for the communication protocol conversion module;
the communication protocol conversion modules waiting for an editing/modifying command issued from the computer;
judging whether the communication protocol conversion modules receiving an editing command issued from the computer;
when the communication protocol conversion module receiving an editing command issued from the computer, the computer sending a communication command protocol to the communication protocol conversion module for editing;
saving the communication command protocol to a storage unit of the communication protocol conversion module for editing;
when the communication protocol conversion module does not receive the modifying command issued from the computer, the method is back to the step of the communication protocol conversion modules waiting for an editing/modifying command issued from the computer;
when the communication protocol conversion modules receiving the modifying command issued from the computer; selecting a communication protocol number to modify the communication protocol conversion module corresponding to the communication protocol number and requiring modification;
the communication protocol conversion module requiring modification outputting the communication command protocol to the computer;
the computer sending a modified communication command protocol to the communication protocol conversion module; and
storing the modified communication command protocol to the storage unit of the communication protocol conversion module.

9. The method as in claim 8, wherein the storage unit is a non-volatile memory.

10. The method as in claim 8, further comprising the steps of:
judging whether the communication protocol conversion module receiving a begin command from the computer;
when the communication protocol conversion module does not receive a begin command from the computer, the method is back the step of the communication protocol conversion modules waiting for commands issued from the computer;
when the communication protocol conversion module receives a begin command from the computer, the display of the computer shows a reply message sent to the computer from the communication protocol conversion module.

11. The method as in claim 8, further comprising the steps of:
judging whether the communication protocol conversion module requiring edit still needs edit;
when the communication protocol conversion module does not need edit, the method is back to the step of the communication protocol conversion modules waiting for an editing/modifying command issued from the computer;
when the communication protocol conversion module needs edit, the method is back to the step of storing the modified communication command protocol to the storage unit of the communication protocol conversion module.

12. The method as in claim 8, further comprising the steps of:
judging whether the communication command protocol needs modification;
when the communication command protocol needs not modification, the method is back to the step of the communication protocol conversion modules waiting for an editing/modifying command issued from the computer;
when the communication command protocol needs modification, the method is to the step of the computer sending a modified communication command protocol to the communication protocol conversion module;
judging whether the communication command protocol needs editing;
when the communication command protocol needing modification needs not editing, the method is back to the step of the communication protocol conversion modules waiting for an editing/modifying command issued from the computer;
when the communication command protocol needing modification needs editing, the method is to the step of storing the modified communication command protocol to the storage unit of the communication protocol conversion module.
